(19) United States
(12) Patent Application Publication
(10) Pub. No.: US 2012/0186042 A1
(43) Pub. Date: Jul. 26, 2012

(54) HINGE FOR FURNITURE

(75) Inventor: Luciano Salice, Carimate (Como) (IT)

(73) Assignee: ARTURO SALICE S.P.A., Novedrate (Como) (IT)

(21) Appl. No.: 13/146,384

(22) PCT Filed: Sep. 17, 2010
(86) PCT No.: PCT/EP2010/063688

§ 371 Date: Jul. 26, 2011

(30) Foreign Application Priority Data
Oct. 13, 2009 (IT) MI2009A 001743

(51) Int. Cl. E05F 1/12; E05D 11/10

(52) U.S. Cl. 16/297; 16/302

(57) ABSTRACT

The hinge (1) for furniture comprises a first and a second swinging arm (2, 3) hinged at their ends by means of pins (12, 13, 14, 15) to a box-shaped body (4) designed to be attached to a swinging portion (5) of the furniture and to a hinge arm (6) suitable for being attached to a fixed portion (7) of the furniture, a bending spring (8) also being provided, that has a first spring arm (9) presenting a profile (17a, 17b) for sliding against a cam (10) provided at one end of the first swinging arm (2), and a second spring arm (11) engaging with the hinge arm (6) or with the box-shaped body (4), the spring (8) being designed to exert a thrusting force on the cam (10) by means of its profile (17a, 17b) so as to enable the rotation of the first swinging arm (2) in the closing direction of the swinging portion (5), the sliding profile (17a, 17b) comprising a first stretch (17a) that engages with the cam (10) during the final part of the angular closing stroke of the swinging portion (5) and a second stretch (17b) that engages with the cam (10) during the initial part of the angular closing stroke of the swinging portion (5) and that, with respect to the extension of the first stretch (17a), it has an angle of deflection (19) from the side facing towards the cam (10), by means of which the thrusting force (F) acquires the arm force (B) needed to operate the rotation of the first swinging arm (2) in advance.

The present invention relates to a hinge for furniture of the type comprising a hinge arm suitable for being fixed directly or indirectly to a fixed element of the piece of furniture, as box-shaped element suitable for being fixed to a swinging portion of the piece of furniture, for example a door, and a first and a second swinging arm that operatively connect the box-shaped body and the arm to each other defining an articulated quadrilateral therewith.

Such hinges usually have springs of various types for creating a return force for closing and/or opening the doors they are attached to.

In a currently widespread embodiment solution, the return spring, of the bending type, is wound around a pin fixed to the hinge arm, preferably around the hinging pin of the second swinging arm to the hinge arm, and has a first arm that abuts against the hinge arm and a second arm that abuts against a control cam provided on the first swinging arm.

The hinges of the above type, with closing return force on the swinging portion of the piece of furniture, have a return spring that exerts an irregular thrust on the swinging portion during the closing stroke. In fact, as known, the thrust exerted by the return spring is proportional to its deformation and to the thrust force arm with respect to the hinging pin of the control cam. Often, during the angular closing stroke of the swinging portion, the return spring deformation decreases more quickly than what the thrust force arm can increase, with the result that the thrust on the swinging portion tends to progressively decrease.

In other cases, on the other hand, the spring deformation may vary in a limited manner, but the thrust force arm does not increase in such a manner as to impart the desired force on the swinging portion in the desired swinging range. This situation may also cause the onset of a stall condition of the swinging portion, for those hinges provided with a device for decelerating the closing of the swinging portion, if the braking action of the decelerating device becomes too quickly prevalent compared to the closing thrust action exerted by the return spring.

The technical task of the present invention therefore is to provide a hinge for furniture with closing return spring which allows eliminating the aforementioned technical drawbacks of the prior art.

Within the scope of this technical task, an object of the invention is to make a hinge for furniture with closing return spring which allows a highly regular closing of the swinging portion.

Another object of the invention is to make a hinge for furniture with closing return spring which allows a regular closing without the onset of stall conditions also when the hinge is provided with a device for decelerating the closing.

Another object of the invention is to make a hinge for furniture with closing return spring which is mechanically highly resistant, sturdy, lasting and accurate in its operation, besides simple and inexpensive.

The technical task, as well as these and other objects, according to the present invention are achieved by providing a hinge for furniture according to claim 1.

Further features of the present invention are further defined in the following claims.

Advantageously, the spring arm that engages against the cam provided at the swinging arm end is configured so as to generate an almost constant rotation torque during a defined portion of the angular closing stroke of the swinging portion.

The provision of an angle of deflection of the second portion relative to the first portion of the spring arm that engages against the cam allows imparting before the thrust force, the force arm required for actuating in rotation the swinging portion with respect to that imparted by the known springs.

This allows providing the hinge with a closing deceleration device without risking the onset of stall conditions, since the closing thrust generated by the spring is exerted starting from an angular position of the closing stroke of the swinging portion always before that when the decelerating device starts operating.

Further features and advantages of the invention will appear more clearly from the description of a preferred but non-exclusive embodiment of the hinge for furniture according to the invention, illustrated by way of a non-limiting example in the accompanying drawings, wherein:

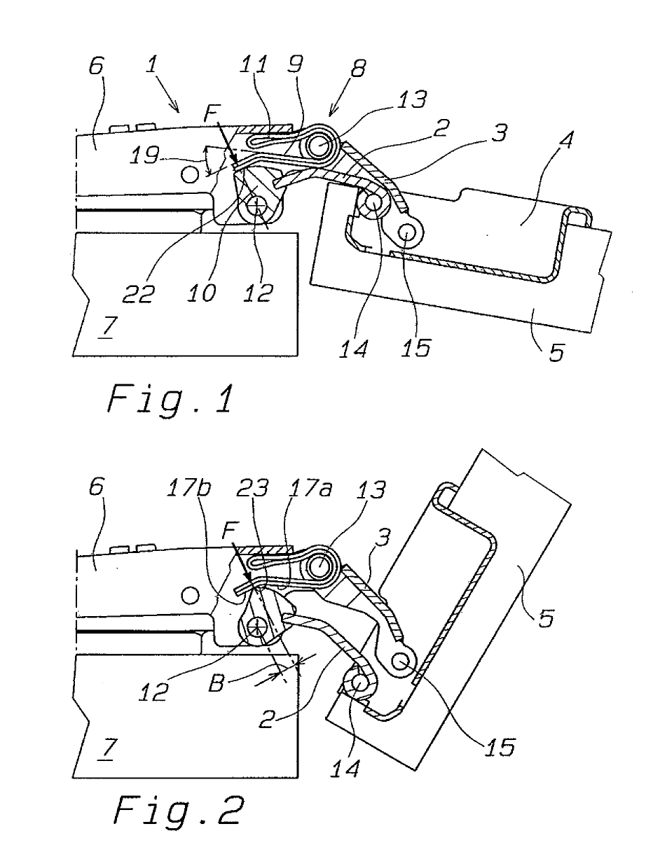

FIGS. 1, 2, 3 and respectively 4 show a partial longitudinal section of a hinge according to a first preferred embodiment of the invention, in the angular positions that the swinging portion sequentially takes during its angular closing stroke;

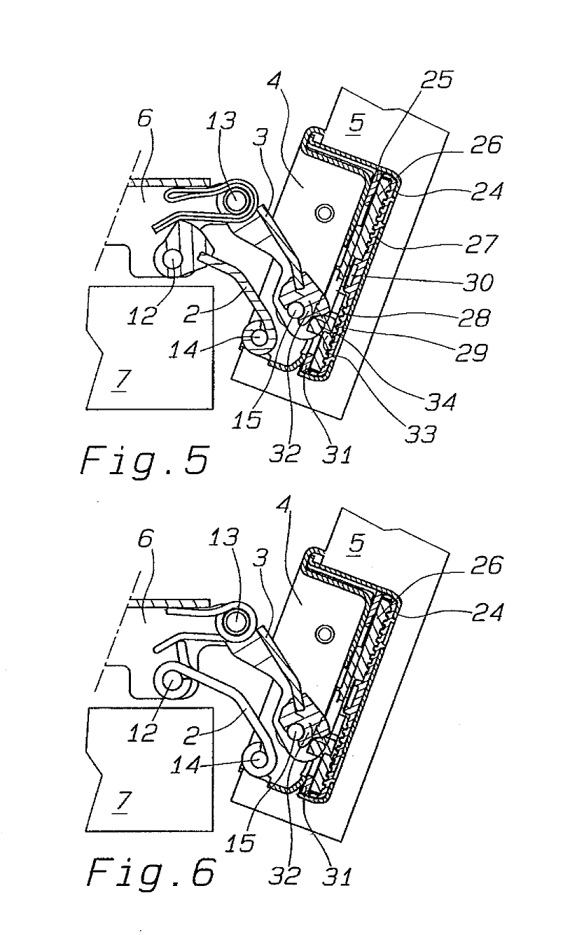

FIG. 5 shows a longitudinal section of a hinge according to the first preferred embodiment of the invention, provided with a closing deceleration device; and

FIG. 6 shows a longitudinal section of a hinge according to a second preferred embodiment of the invention, provided with a closing deceleration device.

Equivalent parts of the different preferred embodiments of the invention shall be indicated with the same reference numeral.

With reference to the above figures, there is shown a hinge for furniture, globally indicated with reference numeral 1.

Hinge 1 comprises a first swinging arm 2 hinged at an end thereof through a pin 12 to a hinge arm 6 suitable for being attached to a fixed portion 7 of the furniture, and at the other end thereof through a pin 14 to a box-shaped body 4 suitable for being attached to a swinging portion 5 of the furniture.

A second swinging arm 3 of hinge 1 is hinged at an end thereof through a pin 13 to the hinge arm 6, and at the other end thereof through a pin 15 to the box-shaped body 4.

Hinge 1 is reversibly actuable between an initial opening configuration (shown in FIG. 1) of the swinging portion 5 and a final closing configuration (shown in FIG. 4) of the swinging portion 5 wherein it is next to the fixed portion 7.

Hinge 1 is provided with a bending spring 8 having a first spring arm 9 having a profile 17a, 17b for sliding against a cam 10 provided at an end of the first swinging arm 2 and a second spring arm 11 engaged with one between the hinge arm 6 and the box-shaped body 4.

Spring 8 may be of the flat band type (FIGS. 1-5) or of wire (FIG. 6).

Cam 10 may be fitted in the first swinging arm 2 (FIGS. 1-5) or it may be obtained in a single piece with the first swinging arm 2 (FIG. 6).

In the solution shown, cam 10 is provided on the end of the first swinging arm 2, hinged through pin to the hinge arm 6 and spring 8 is wound around the hinging pin 13 of the second swinging arm 3 to the hinge arm 6, with which the second spring arm 11 in turn engages.

Spring 8 is suitable for exerting a thrust force F on cam 10 through its profile 17a, 17b for rotating the first swinging arm 2 in the closing direction of the swinging portion 5.

The sliding profile 17a, 17b comprises a first portion 17a that engages with cam 10 during the final part of the angular closing stroke of the swinging portion 5 and a second portion 17b that engages with cam 10 during the initial part of the angular closing stroke of the swinging portion 5.

The second portion 17b advantageously, with respect to the extension of the first portion 17a, has an angle of deflection 19 on the side facing cam 10.

Thanks to the provision of the angle of deflection 19, during the initial part of the angular closing stroke of the swinging portion 5 the thrust force F acquires the arm force B needed to operate the rotation of the first swinging arm 2 in advance (compared to the case when the angle of deflection 19 is not provided).

The angle of deflection 19 is achieved by means of an intermediate bending 18 of the first arm 9 of spring 8.

Preferably, the two sides 20, 21 of the first arm 9 formed by the angle of deflection 19, of which the first side 20 has the first portion 17a of the sliding profile and the second side 20 has the second sliding portion 17b, are substantially rectilinear and jointed to each other by an arc of small radius, preferably less than the distance of cam 10 from its centre of rotation 12.

With reference to the embodiments illustrated in FIGS. 1-5, cam 10 has a neutral stretch 22 whereat the first arm 9 of spring 8 transmits a thrust force F directed radially towards pin 12. Such thrust force therefore has no effect in the rotation of the first swinging arm 2.

The neutral stretch 22 is shaped as an arc with radius having center at pin 12.

The operation of hinge 1 during the angular closing stroke of the swinging portion 5 is illustrated with reference to the embodiments of FIGS. 1-4.

Spring 8 is initially engaged with the second portion 17b of its first arm 9 in the neutral stretch 22 of cam 10 (FIG. 1).

At the beginning of the closing stroke of the swinging portion 5, points each time different of the neutral stretch 22 of cam 10 and of the second portion 17b of the first arm 9 of spring 8 come in contact with each other.

When a certain angle of the angular closing stroke of the swinging portion 5 is achieved, as illustrated in FIG. 2, the second portion 17b of the first arm 9 of spring 8 leaves the neutral stretch 22 of cam 10 and engages an edge 23 of cam 10. From here to the end of the angular stroke of the swinging portion 5, this edge 23 will slide along the first arm 9 of spring 8.

The thrust action in rotation of the first swinging arm 2 begins right at the position of hinge 1 illustrated in FIG. 2, where it is seen that the thrust action F acts on cam 10 according to an action straight line having an arm B with respect to pin 12 wherein cam 10 is hinged.

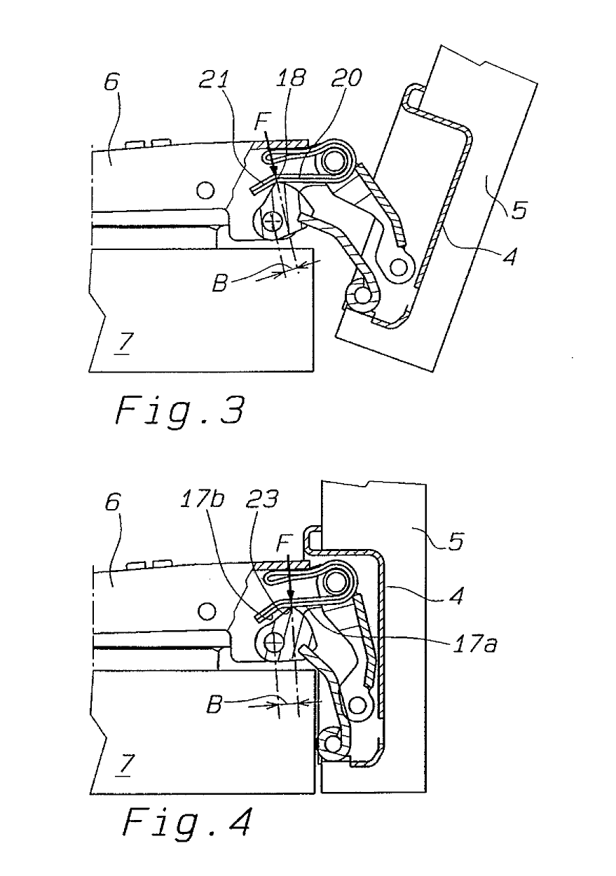

As the angular closing stroke of the swinging portion 5 continues, edge 23 of cam 10 slides along the entire second portion 17b of the profile of the first arm 9 of spring 8, achieving bending (FIG. 3) and after that it covers the first portion 17a of the profile of the first arm 9 of spring 8 up to the position corresponding to the closing of the swinging portion 5 (FIG. 4).

One of the main aspects of the invention is that hinge 1 is configured so that as the closing of the swinging portion 5 continues, the elastic force F generated by spring 8 decreases substantially inversely proportional to the increase of arm B with which said elastic force F acts on cam 10 for actuating the first swinging arm 2 in rotation.

The resulting effect is the imparting of an almost constant rotation torque that causes a very regular closing of the swinging portion 5.

The advance in imparting the rotation torque, which as seen begins at the hinge configuration illustrated in FIG. 2 (when the swinging portion 5 has an angle of about 30°-35° relative to its closing position), makes it especially convenient to combine the spring closing thrust system as described and a closing deceleration device in hinge 1 since it is possible to ensure the delay of the triggering of the decelerating device with respect to the triggering of the closing thrust system, thus preventing the onset of stall conditions of the swinging portion 5, which would require the user's intervention to complete the closing of the swinging portion 5.

The decelerating device, of the known type, is shown in FIGS. 5 and 6.

It comprises a container 24 with cover 25 applied on the outer side of the bottom of box 4 of hinge 1.

Container 24, filled with viscous fluid, contains a braking disc 26 turnably carried by a central rotation pin 30 of base 27 of container 24.

On the side facing base 27, the braking disc 26 has circular relieves 28 concentric to its axis of rotation and engaged into corresponding circular impressions 29 again concentric to the axis of rotation of the braking disc 26 and obtained on the side of base 27 facing the same braking disc 26.

A shifting cursor 31 is also provided in container 24 which on one side engages with a cam 32 carried at the end of the second swinging arm 3 hinged in pin 15, and on the other side with the braking disc 26.

Cursor 31 is adapted for taking its movement from cam 32 and transforming it into a rotation of the braking disc 26.

In particular, the braking disc 26, for receiving the movement, has a cam 33 on the side facing cursor 31 wherein a projection 34 of cursor 31 engages.

During the angular closing stroke of the swinging portion 5, the triggering of the decelerating device occurs after that of the spring closing thrust system, that is, when the swinging portion 5 has an angle of about 15°-20° relative to its closing position (equivalent to the position illustrated in FIG. 3 for the hinge without closing decelerator).

Several changes and variations can be made to the hinge thus conceived, all falling within the scope of the inventive concept; moreover, all details can be replaced with technically equivalent elements.

In the practice, the materials used as well as the sizes, can be whatever, according to the technical requirements and to the prior art.

1. A hinge (1) for an item of furniture of the type comprising a first and a second swinging arm (2, 3) hinged at their ends by means of pins (12, 13, 14, 15) to a box-shaped body (4) designed to be attached to a swinging portion (5) of the furniture and to a hinge arm (6) suitable for being attached to a fixed portion (7) of the furniture, a bending spring (8) also being provided, that has a first spring arm (9) presenting a profile (17a, 17b) for sliding against a cam (10) provided at one end of the first swinging arm (2), and a second spring arm (11) engaging with the hinge arm (6) or with the box-shaped body (4), said spring (8) being designed to exert a thrusting force (F) on the cam (10) by means of its profile (17a, 17b) so as to enable the rotation of the first swinging arm (2) in the closing direction of the swinging portion (5), characterised in that the sliding profile (17a, 17b) comprises a first stretch (17a) that engages with the cam (10) during the final part of the angular closing stroke of the swinging portion (5) and a second stretch (17b) that engages with the cam (10) during the initial part of the angular closing stroke of the swinging portion (5) and that, with respect to the extension of the first stretch (17a), it has an angle of deflection (19) from the side facing towards the cam (10), by means of which the thrusting force (F) acquires the arm force (B) needed to operate the rotation of the first swinging arm (2) in advance, said angle of deflection (19) being achieved by means of an intermediate bending (18) of the first arm (9) with an arc of lesser radius than the distance of the cam (10) from its axis of rotation (12).

2. (canceled)

3. A hinge (1) for an item of furniture according to claim 1, characterised in that the two sides (20, 21) of said first arm (9) identified by the angle of deflection (19) are substantially straight.

4. A hinge (1) for an item of furniture according to claim 1, characterised in that the cam (10) has a curved stretch (22), the radius of which is in line with the centre of the pin (12) in which the end of the first swinging arm (2) carrying said cam (10) is hinged, and in that the second stretch (17b) engages with the curved stretch (22) in line with the initial position of the angular closing stroke of the swinging portion (5).

5. A hinge (1) for an item of furniture according to claim 1, characterised in that the cam (10) is on the end of the first swinging arm (2), hinged to the hinge arm (6), and the spring (8) is wound around the pin (13) on which the second swinging arm (3) is hinged to the hinge arm (6), with which the second spring arm (11) engages.

6. A hinge (1) for an item of furniture according to claim 1, characterised in that the spring (8) is made of wire.

7. A hinge (1) for an item of furniture according to claim 1, characterised in that the spring (8) is made of flat band.

8. A hinge (1) for an item of furniture according to claim 1, characterised in that the cam (10) is attached to the end of the first swinging arm (2).

9. A hinge (1) for an item of furniture according to claim 1, characterised in that the cam (10) and the first swinging arm (2) are made in a single piece.

10. A hinge (1) for an item of furniture according to claim 1, characterised in that it contains a device for braking the closing of the swinging portion (5).
